(19) United States
(12) Patent Application Publication
(10) Pub. No.: US 2008/0145202 A1
(43) Pub. Date: Jun. 19, 2008

(54) Apparatus and Method for Separating Differing Vertically Oriented Containers

(76) Inventor: John Riedl, Northbridge (AU)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/858,643

(22) Filed: Sep. 20, 2007

Related U.S. Application Data
(63) Continuation of application No. PCT/AU2006/000384, filed on Mar. 23, 2006.

(30) Foreign Application Priority Data
Mar. 23, 2005 (AU) AU 2005901425

(51) Int. Cl. B65G 57/32; B07C 5/36

(52) U.S. Cl. 414/788.9; 209/522; 414/800

(57) ABSTRACT

This invention discloses an apparatus for separating differing vertically orientated containers 11, 12, particularly for use in manufacturing operations. The apparatus includes at least one pair of parallel guides 10 substantially aligned in a direction of travel of the containers 11, 12. The pair of guides 10 are operatively positioned to receive the containers 11, 12 therebetween. The distance W between the pair of guides 10 is between but not equal to the largest and smallest diameter or width of the containers 11, 12. There is also disclosed a method and apparatus for stacking containers employing the separation apparatus.

### CROSS REFERENCE TO RELATED APPLICATION(S)

This application is a continuation application of International Application No. PCT/AU2006/000384, filed Mar. 23, 2006 and published as WO 2006/099673 A1 on Sep. 28, 2006, which claims priority to Australian Patent Application Serial No. 2005901425, filed Mar. 23, 2005, and claims the priority thereof, the subject matter of which is hereby incorporated by reference in its entirety.

### FIELD OF THE INVENTION

The present invention relates to manufacturing operations, and in particular to a method and apparatus for the separating of containers during a manufacturing operation.

### BACKGROUND OF THE INVENTION

In manufacturing operations, speed of the production line and enhanced productivity are the two key goals sought by manufacturers.

There are a number of manufacturing operations that produce containers that are typically used in conjunction with food for trading in locations such as supermarkets, bakeries, pie shops and other take away food shops. These containers can be made from a variety of materials, such as plastic, paper or paper composites and aluminium foil. For example, aluminium food containers (or dishes) are used to hold food such as pies, pasties, pasta and lasagna products. Typically, the containers used for this purpose are initially open-topped and hollow, and are usually manufactured so they can be stacked on top of and within one another prior to use.

In one common form of manufacture, the manufacture of such containers begins with the material, such as aluminium foil or paper, being fed into a stamping press which forms the shape of the container using a die. Other forming processes can be used for other materials.

The formed containers are then ejected from the press or other shaping process at a range of speeds depending upon the die or tool used to form the container, the speed of the press, and the size, weight, shape and material of the container. Typically, ejection speeds from tens of containers per minute up to several hundreds of containers per minute are experienced.

After the containers have been formed and ejected from the press or process, they need to be stacked in pre-determined quantities for packaging and shipping to the customer.

The containers may be ejected from the press by various means. For example, the containers may be ejected by mechanical means such as a piston or pushing mechanism contained within the die. Alternatively, the containers may be ejected using a blast of compressed air. In recent designs, the containers are ejected using a combination of an ejection mechanism and an air blast.

Irrespective of the method of ejection used, the containers so ejected are then often transferred to a stacking operation using a conveyor means. Such a conveyor may be powered using a moving belt or a multiplicity of belts, or unpowered comprising a chute operating under gravity.

In one form of art used for stacking, the containers are randomly caught in a net or other similar containment means situated at the end of the conveyor or chute. A human operator then physically counts and stacks the containers ready for shipment. Counting may be assisted by measuring gauges or weighing scales. While this method works with all types of container it is generally slow or expensive in labour content or both.

In another form of art used for stacking, the containment means may be a shaker table, which assists small round or square containers to nest within each other whilst being shaken. A human operator then collects the partially formed stacks and counts and assembles the required quantity of containers in each stack. Once again, measuring gauges or weighing scales may be used to assist. Overall, this provides a rudimentary semi-automatic stacking system, where the speed and productivity are still based upon the inherent limitations of a human operator.

The shaker table method of stacking is generally limited to use with small containers. Medium and large containers are prone to damage using this method and do not tend to nest correctly or sufficiently quickly in large enough stacks. These problems are exacerbated with rectangular containers, and such containers are generally not workable with this form of stacking. Thus, for larger containers and also for rectangular or other shapes of container than circular or square, other forms of semi-automatic or automatic stacking are required to economically produce containers where labour costs may otherwise be high.

One problem with automating the stacking operation was the randomness of orientation and direction with which some containers were ejected from the press or machine. Depending on the speed of production, the shape and size of the container and the method of ejection used, the containers can settle on the initial conveyor, net or shaker both right way up and upside down, as well as at any point along and across the conveyor within a broad range. Further, where the containers are not round, they may be orientated in a variety of ways relative to the direction of travel along the conveyor or chute. The speed of the production line would be increased if the containers could be sorted into a more uniform orientation prior to any stacking operation.

In a current state of the art, guides are positioned above the conveyor means and as close to the die as practicable to guide the containers into constant starting positions with a pre-determined orientation. Sometimes a combination of guides is used. After the use of a set of guides appropriate to the size, shape and orientation of container being ejected, the majority of the containers are positioned at desired distances across the conveyor.

The homogenous order and position of the containers then allows for further semi-automatic and automatic stacking means. For example, in one state of the art, a curved metal chute which tilts the container from the horizontal to the vertical by allowing it to fall an amount slightly longer than the container's own length, is positioned after the guiding conveyor and forces the container onto one of its side or ends after the initial conveyor system. The container falling over the curved metal chute falls onto a second conveyor whereupon rests a nested stack of containers all on their sides or ends as desired. A small puff of air is then typically applied to the last container to fall to assist it to nest side-ways in the formed stack. The stack is then conveyed by the second conveyor at a rate appropriate to allow additional containers to fall and nest. This is typically called a “Waterfall” Stacker. The actual stacking process is semi-automatic; however an operator is still required to watch for upside down or incorrectly positioned containers and to adjust the stack periodically. Further, the stack could be of arbitrary size, and a human operator is typically used in order to break up the stacks into the desired number of containers for packaging.

Achieving the desired number of containers in a stack can be the result of human counting, or alternatively could be counted by height or weight. Alternatively, a mechanical counting device is sometimes used which places a coloured piece of paper, plastic or metal after a certain number of containers in the stack.

In order to allow more containers to be stacked in the fastest time possible, a multi-channel tool or die with subsequent multi-channel conveyor is often used. This allows for two or more parallel stacks to be formed at the same time. In some cases, a further conveyor, positioned immediately after the first conveyor and known as a separation conveyor, is often used to increase the distance between the containers prior to stacking. This allows for improved feeding of the containers onto the stack, as well as providing separation between the containers.

The above forms of the art still require a human operator to perform a major role in the stacking process. This has inherent limitations in productivity and speed of the process. In high volume manufacturing processes, automatic stacking is preferred as it increases manufacturing speed and lowers labour content.

In the current form of automatic stacking means, a single or multi channel initial conveyor, known as the receiving conveyor, receives the containers from the stamping press or similar and guides them into channels. A separation conveyor is then often situated after the receiving conveyor to control the speed and increase the distance between the containers prior to entering the automatic stacking means.

At the end of the separation conveyor, each container is dropped into a stacker head. This consists of a pair of vertical guides parallel to the container and conveyor direction at a slightly larger width than the containers, together with a stop plate perpendicular to the guides at a certain distance from the edge of the conveyor to ensure the container does not travel too far past the end of the conveyor. Once the dish is in the stacker head, after hitting the stop plate it drops vertically onto the stacking assembly. As the process is repeated, a stack is formed within the stacking assembly. The dropping of the container may be assisted by a puff of compressed air or other mechanical means.

In a current state of the art, the stacking assembly typically consists of an elevator mechanism and a number of auxiliary mechanisms. The elevator consists of a horizontal surface to catch the bottom container in the stack. As more dishes are dropped onto the stack, the elevator moves downwards a certain distance, often in jerks, such that the top of the stack stays approximately constant in height. The constant height provides a relatively constant environment for each dish to enter the stacking mechanism and drop on top of the stack already formed. Typically, there are also adjustable vertical guides on either side of the elevator mechanism in order to prevent the stack from toppling over. The elevator continues to descend until the desired number or height of containers is achieved. At this point an auxiliary catching mechanism is typically used to catch the containers dropping from the conveyor while the elevator moves to the bottom of its range to clear the previous stack. Once the auxiliary mechanism is engaged, the elevator descends to an unloading position.

An improved form of stacking assembly is described in co-pending International PCT Application No. PCT/AU2006/00297 of the present applicant, Kingfoil Containers Pty Ltd, entitled “Apparatus and Method for Stacking Containers” (hereinafter named the “co-pending application”). In this application, there is disclosed an apparatus for the stacking of containers, including a plurality of substantially horizontal pairs of gates positioned in a substantially vertical series wherein operatively each said gate pair can be selectively closed or opened to allow said containers to either rest at each gate pair or pass through, so as to deliver a stack of containers below said gate pairs.

While the containers ejected from the press may be guided into relatively constant position and horizontal orientation, not all containers are always positioned the same way up. For larger containers, this is usually not a substantial problem, as most, if not all, are positioned the same way. Small containers, however, are produced at very high speed, typically over 150 containers per channel per minute. This speed and the aerodynamics of the container when it is ejected results in some containers being inverted when ejected from the conveyor and some not. If a container is the wrong way up, it can not stack upon the other containers and an automatic stacking process must be interrupted in order remedy the problem. Due to the speeds involved, this is generally impractical and therefore automatic stackers of the elevator type or the improved form of stacking assembly as described in the co-pending application cannot be used. The less efficient shaker table arrangement is often used or purely manual collection is used. Thus, there is a need for an automatic method for dealing with the random vertical orientation of containers prior to reaching any type of stacking means.

It is an object of the present invention to provide a means for separating and stacking differently vertically orientated containers that does not require substantial human interaction.

### SUMMARY OF THE INVENTION

The majority of containers have, to some extent, a different diameter or width at the top of the container than the base, with the open top typically having a larger diameter/width than the closed bottom. This allows for the stacking of the containers within each other. This may be achieved by having the sides of the containers inclined outwardly from the bottom of the container. Alternatively or in addition to, some containers have a form of lip around the top of the container so that there is an extruding part around the container. The present invention is limited to such types of containers.

According to a first aspect of the present invention, there is provided an apparatus for separating containers that are of differing vertical orientation comprising at least one pair of parallel guides substantially aligned in a direction of travel of the containers, the pair of guides being operatively positioned to receive the containers therebetween, wherein the distance between the pair of guides is between but not equal to the largest and smallest diameter or width of the containers.

Preferably, the pair of guides are aligned in a substantially horizontal direction.

According to a second aspect of the present invention, there is provided an apparatus for stacking containers that are of first and second vertical orientations comprising:

a first stacking apparatus;

at least one pair of parallel guides arranged above the first stacking apparatus and substantially aligned in a direction of travel of the containers, the pair of guides being operatively positioned to receive the containers therebetween, wherein the distance between the pair of guides is between but not equal to the largest and smallest diameter or width of the containers, so that only containers having the first orientation enter the first stacking apparatus; and

a second stacking apparatus, positioned in series with the first stacking apparatus, to receive the containers having the second orientation.

Preferably, the pair of guides are aligned in a substantially horizontal direction.

According to a third aspect of the present invention, there is provided a method for the stacking of containers having a first and second vertical orientation comprising:

providing at least a first stacking apparatus;

providing at least one pair of parallel guides arranged above the at least first stacking apparatus and substantially aligned in a direction of travel of the containers, the pair of guides being operatively positioned to receive the containers therebetween, wherein the distance between the pair of guides is between but not equal to the largest and smallest diameter or width of the containers;

allowing the containers to travel along the guides whereby containers having the first orientation will fall through the guides into the first stacking apparatus, and the containers having the second orientation will not fall through the guides.

Preferably, there is provided a second stacking apparatus positioned in series with the first stacking apparatus wherein the containers of the second orientation will fall into the second stacking apparatus. This provides for two separate stacks to be automatically formed depending upon the vertical orientation of the containers.

The width of the containers is a value dependant upon the shape of the containers, and for containers being generally circular, the width is simply the diameter. For other containers, it may be the minimum width, for example for an oval container. The width may of course vary with the height of the container, and generally the largest width is that of the open mouth of the container and the smallest width is that of the closed base. In general, the guides need to be spaced having regard to the actual product shape at a spacing which is operative to achieve the necessary separation.

The present invention allows for containers that are all of the same vertical orientation to be automatically separated from those containers of the opposite vertical orientation. This is provided by having a pair of guides set at a certain width to allow containers that are of one orientation to rest on top or within the guides, while those of the other orientation will fall through the guides.

The present invention also allows for the stacking of containers of each orientation without requiring substantial human interaction to flip the containers into the same orientation. If the guides are positioned above a stacking apparatus, only the containers that are of one orientation fall through into the first stacking apparatus. The containers of the opposite orientation will rest upon the guides and either by momentum or mechanical force such as provided by an air-jet or other means will travel beyond the first stacking apparatus.

The present invention overcomes the problems in the prior art by not requiring a human operator to physically watch for mis-orientated containers and then subsequently flip these over which is impractical at the speeds required for efficient operation. The present invention does not require the containers to be of the same orientation prior to exiting the conveyor system. The present invention therefore provides an automatic means for stacking differently vertically orientated containers.

### BRIEF DESCRIPTION OF THE DRAWINGS

Further features and aspects of the invention will become apparent from the following description of preferred embodiments given in relation to the accompanying drawings, in which:

FIGS. 1A and 1B are end views of an embodiment of the apparatus according to the present invention;

FIG. 1C is a perspective view of an embodiment of the apparatus according to the present invention;

FIG. 2 is a perspective view of an embodiment of the apparatus according to the present invention;

FIG. 3 is a top view of an embodiment of the use of the apparatus according to the present invention; and

FIG. 4 is a side view of the embodiment of FIG. 3.

### DESCRIPTION OF PREFERRED EMBODIMENT

In order that the invention might be more fully understood, embodiments of the invention will be described with reference to the accompanying drawings. Further optional and preferred features and advantages of the apparatus and method of the present invention will become apparent from the following description of these preferred embodiments. However, the embodiments described herein below should not be considered as limiting the scope of the invention of any of the preceding statements.

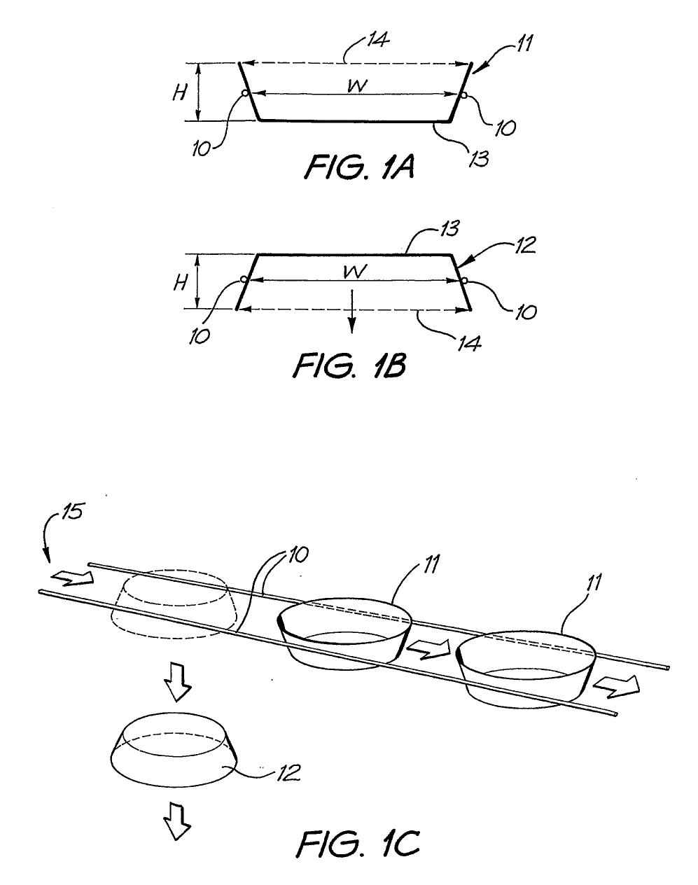

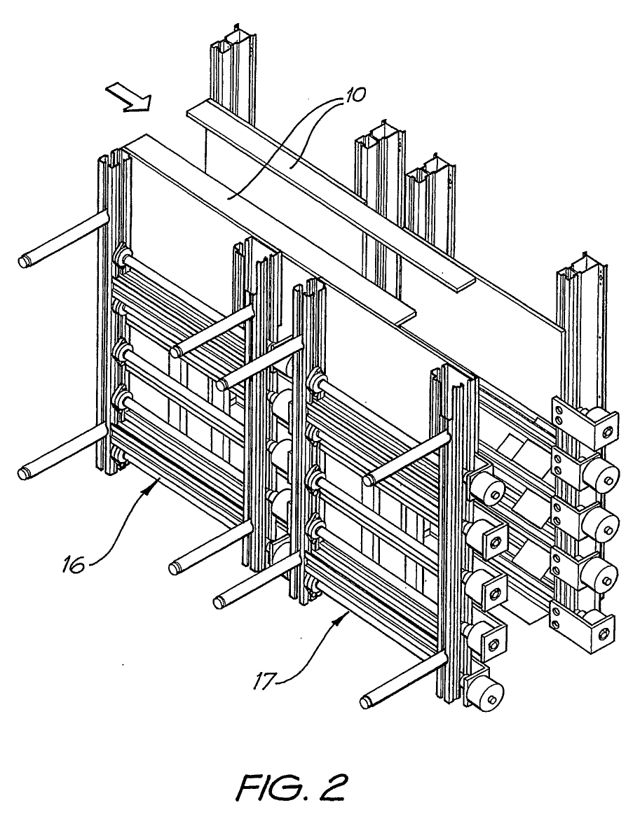

FIGS. 1A and 1B show end views of the guides 10 for both the right way up container 11 and inverted container 12. The guides are positioned such that the width W between the guides 10 is set larger than the width of the base 13 of the containers 11, 12 but smaller than the width of the top 14 of the containers 11, 12.

FIG. 1C shows a perspective view of the guides 10 in use for separating containers. The containers enter the guides 10 from the end 15. The inverted container 12 is not caught by the guides 10 since the width W of the guides 10 is larger than the width of the base 13 of the container and thus falls through the guides. The right way up containers 11 are caught by the guides 10 since the width W of the guides is smaller than the width of the top 14 of the container and thus do not fall through the guides 10, instead resting within or on top of the guides 10.

The guides 10 may take many different forms. In one embodiment, the guides 10 may be lengths of wire. In another embodiment, the guides 10 may be lengths of metal or plastic for example and of suitable cross-section. The guides 10 are functionally required to achieve the separation required, and any physical form which achieves this can be used.

FIG. 2 shows a perspective view of an embodiment of the invention. The guides 10 in this embodiment are rectangular lengths of metal or other material that are attached to the stacking apparatus 16. The stacking apparatus 16 shown is a variation of that disclosed in the co-pending application although other forms of stacking apparatus may be used. In this embodiment, two stacking apparatus 16, 17 are used in series. This enables the inverted containers 12 to fall into the first stacking apparatus 16 while the right way up containers will travel further along the guides 10 to fall into the second stacking apparatus 17. FIG. 2 shows a single channel stacking apparatus 16, although multiple channels may be used in the same way. While FIG. 2 shows the first and second stacking apparatus 16, 17 arranged conveniently in line with one another, it will be appreciated that the first and second stacking apparatus could be arranged offset from one another, provided that the function of separation of inverted from non-inverted containers occurs using guides is maintained. As will be later explained, there can be advantages in having an offset arrangement of the first and second stacking apparatus.

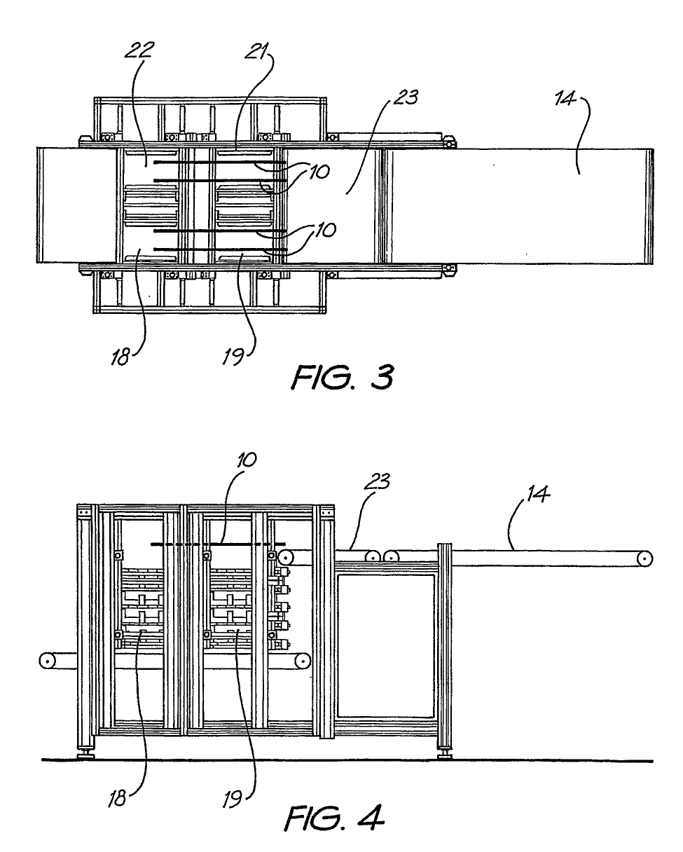

FIG. 3 and FIG. 4 show an embodiment of the present invention in use with two, two-channel stacking apparatus 18, 19 in series. The production line begins with the stamping press (not shown) forming the shape of the container. The present invention can be used for stacking containers made out of a variety of materials including, but not limited to, aluminium foil, plastics of different formulations, paper or paper composites. The stamping press may be any suitable apparatus for the formation of the containers, the exact features and types of such press depending upon the material from which the container is made. The press itself does not form part of the present invention, and so will not be described in detail. It will be understood that the press may be replaced depending upon the relevant manufacturing process, for example by an injection moulding machine for plastic containers.

The containers are ejected from the press onto an input conveyor 14. The input conveyor 14 ideally consists of guides situated above the conveyor in order to align and orientate the containers into a constant position across the width of the input conveyor 14. If a multi-channel stacker is used, there should ideally be multiple sets of guides in order to produce multiple alignments of containers ready for input into each channel of the stacker apparatus 19 and 21.

In the embodiment shown in FIG. 3 and FIG. 4, there is provided a second conveyor 23, called the separation conveyor. The separation conveyor 23 is run at a faster speed than the input conveyor 14. The increased speed is used to increase the distance between the subsequent containers, thereby separating the containers that are touching or bunched up prior to input into the stacker 19, 21.

When the containers reach the end of the second conveyor 23, they subsequently reach the guides 10. The height of the guides 10 is dependent upon the width and height of the containers, but should be operatively positioned such as to ensure both orientations of containers are theoretically able to enter the guides 10, (even though the inverted containers will not actually be caught by the guides 10). For example, if the guides 10 are positioned too high above the conveyor 23, all the containers fall underneath the guides 10 and will not be separated. Alternatively, if the guides are too low all the containers will be caught in the guides 10 and thus also will not be separated.

When the containers enter the guides 10, the inverted containers fall through the guides 10 into the stacking apparatus 19 or 21. These containers are then stacked in a method depending upon the type of stacker being used. Preferably, the stacker used is that disclosed in the co-pending application and shown in FIG. 2.

The right way up containers are caught by the guides 10. Typically, there is sufficient momentum in the containers from the conveyor exit to reach the end of the guides 10 and thus fall into the second stacker 18 or 22. However, there may be a constant stream or puff of air used to push the right way up containers to the end of the guides 10 and thus into the stacking apparatus 18 or 22, if required. Other mechanical aids could also be used.

The containers are formed into stacks by using the stacking apparatus 16. Depending upon the type of stacker used, the timing may require modification in order to successfully remove the stacks from the stacker and transport them to be packaged and shipped. This is because there is more than one stack being formed in series, thus depending upon the exit means, one stack and hence stacker may need to be removed at a time. For example, in FIG. 2 if a conveyor is positioned below the stacking apparatus for rapid transportation of the stacks, the removal of the second stack from the stacker 17 can not occur while the first stack is being moved underneath it. This problem is exacerbated in multi-channel operation. As in the co-pending application, there may be multiple stackers and hence stacks in parallel as well as in series. If the die stamping out the containers is multi-cavity, there will generally be one channel and hence one set of stacker heads.

Various embodiments may be used to remedy this situation, including using differently directed exit conveyors, or automatically or manually timing each stacker's removal.

In another embodiment of the stacking arrangement, mentioned previously, the guides 10 may be so positioned to allow the stacking apparatus for one orientation of dish to be arranged offset to the side of the other stacking apparatus for the other orientation of dish. In this arrangement, respective stacks formed by each apparatus can exit parallel to each other, thus overcoming the need to have one stack pass under another.

In the preferred embodiment, the stacker used is that disclosed in the co-pending application. The formation, use and preferred embodiments of this stacker are outlined in this co-pending application. Using this stacker, the desired height of the stack may be formed either by closing the lower most gate for the required period of time until the desired number of containers or smaller stacks have stacked upon it. Alternatively, the desired height of the stack is achieved after the stacks have exited the stacker, whilst on the conveyor or platform underneath.

Where there is more than one stacker in series, such as in the preferred form of the present invention, the ability for a stack to be formed either on the lowermost gate or on the conveyor below may not be possible on any but the first stacker if the conveyor is running underneath the stackers parallel to the direction of initial travel of the containers. This is because there stacks being removed from the first stacker in the series will need to pass underneath any subsequent stackers. As such, it is preferable there is no obstruction for any period of time on the conveyor or in the path of the stack formed.

In this situation, if the stacks cannot be offset so that the stacks can exit without one passing under another, the stack is preferably formed of the desired height on a gate that is high enough to allow any stack from the first stacker to pass underneath it. When any one stack is complete on top of this intermediary gate, and there is no other stack passing underneath it, the stack is dropped from the gate onto the conveyor below. It can then be transported away by moving underneath and through and subsequent stacker in series. This alleviates the possibility of any one stack interfering with another and also any unnecessary delay required for clearance of a stack.

It is contemplated that the present invention, in it broadest form, could be implemented using a single stacker. In this case, the incorrectly aligned containers could be shunted to some arrangement for re-orienting the containers, and then re-fed to the same stacker, or alternatively periodically corrected orientated and replaced manually. However, this would not be as advantageous for productivity improvement as the preferred form, and may be difficult to successfully control.

While the present invention has been described with reference to specific embodiments, it will be appreciated that various modifications and changes could be made without departing from the scope of the invention.

What is claimed is:

1. An apparatus for separating containers that are of differing vertical orientation, said apparatus comprising at least one pair of parallel guides substantially aligned in a direction of travel of said containers, said pair of guides being operatively positioned to receive said containers therebetween, wherein the distance between said pair of guides is between but not equal to the largest and smallest diameter or width of said containers.

2. The apparatus according to claim 1, wherein said pair of guides are aligned in a substantially horizontal direction.

3. An apparatus for stacking containers that are of first and second vertical orientations comprising:
a first stacking apparatus;
at least one pair of parallel guides arranged above said first stacking apparatus and substantially aligned in a direction of travel of said containers, said pair of guides being operatively positioned to receive said containers therebetween, wherein the distance between said pair of guides is between but not equal to the largest and smallest diameter or width of said containers, so that only containers having a first orientation enter said first stacking apparatus; and
a second stacking apparatus, positioned in series with said first stacking apparatus, to receive the containers having the second orientation.

4. The apparatus according to claim 3, wherein said pair of guides are aligned in a substantially horizontal direction.

5. The apparatus according to claim 3, wherein said second stacking apparatus is positioned offset from said first stacking apparatus.

6. A method for the stacking of containers having a first and second vertical orientation comprising:
providing at least a first stacking apparatus;
providing at least one pair of parallel guides arranged above said at least first stacking apparatus and substantially aligned in a direction of travel of said containers, said pair of guides being operatively positioned to receive said containers therebetween, wherein the distance between said pair of guides is between but not equal to the largest and smallest diameter or width of said containers;
allowing said containers to travel along said guides whereby containers having said first orientation will fall through said guides into said first stacking apparatus, and said containers having said second orientation will not fall through said guides.

7. A method according to claim 6, further comprising providing a second stacking apparatus positioned in series with said first stacking apparatus wherein said containers of said second orientation will fall into said second stacking apparatus.
